(19) United States
(12) Patent Application Publication
(10) Pub. No.: US 2007/0022091 A1
(43) Pub. Date: Jan. 25, 2007

(54) Access based file system directory enumeration

(75) Inventors: Brian Styles, Coral Springs, FL (US); Charles B. Bucklew, Sunrise, FL (US); Michael Latchminsingh, Boynton Beach, FL (US)

Correspondence Address: FLEIT, KAIN, GIBBONS, GUTMAN, BONGINI;& BIANCO P.L., ONE BOCA COMMERCE CENTER, 551 NORTHWEST 77TH STREET, SUITE 111, BOCA RATON, FL, 33487, US

(73) Assignee: ScriptLogic Corporation, Boca Raton, FL (US)

(21) Appl. No.: 11/186,320

(22) Filed: Jul. 20, 2005

(51) Int. Cl. G06F 17/30

(52) U.S. Cl. 707/2

(57) ABSTRACT

A filtered directory listing system includes a request interface that receives, from a process associated with a user that has a defined set of data object access permissions, a file system directory listing request for a directory stored within an NTFS type file system. The filtered directory listing system further includes a file system interface that receives a file system directory listing for the directory and a directory listing entry processor that determines at least one entry within the file system directory listing, where each of the at least one entry is for a data object to which the user is prohibited access. The filtered directory listing system also includes a filtered directory listing generator that generates a response that consists of the filtered file system directory listing for the directory, where the filtered file system directory listing consists of the file system directory listing with at least one entry removed therefrom.

### BACKGROUND OF THE INVENTION

1. Field of the Invention

This invention generally relates to generating directory listings for computer file systems and more specifically to limit file system directory listings that only have entries for data objects to which the requestor has access.

2. Description of Related Art

Automated processing systems used by individuals and enterprises generate, process and store data on one or more file system devices, such as file servers. Network data communications allows multiple data processors, such as personal computers, to share a particular file system. These file systems are able to store several types of data objects, such as data files and directories. These file systems are able to be hosted, for example, on a personal computer that is connected to a data communications network or on a server computer. Several users who are either using the computer hosting the file system or who are connected to the computer hosting the file system over a network can share file systems and the data stored on those file systems.

Shared file systems are able to use an “NT File System” (NTFS) that can operate with some personal computer operating systems. The NTFS incorporates Access Control Lists (ACLs) that are able to specify permissions for data objects stored on a file system operating under NTFS. An Access Control List is generally a table used by a computer operating system that defines which access rights one or more users has to a particular data object, such as a file or directory. Each data object has a security attribute that identifies its access control list. The ACL is able to have an entry for each system user for whom access privileges are specified. Privileges defined in an ACL include the ability to read a file (or all the files in a directory), to write to the object, and to execute the file (if it is an executable file, or program). In the NTFS, an ACL is able to be associated with each stored data object. Each ACL has one or more Access Control Entries (ACEs) that each includes an identifier for a user or a defined group of users. For each of these users or groups, the access privileges are stored in a string of bits called an access mask. Generally, the system administrator or the owner of the data object creates the access control list for an object.

An ACL available with the NTFS is able to be configured to specify various types of authorizations for the data object associated with that ACL. The authorizations specified in an ACL under NTFS include one or more of allowing everyone, only a particular user, and/or users assigned to a particular group, to be able to perform certain operations on the data object, such as reading or writing to the object. Users can request file system directory listings for a particular directory of data objects stored on the file system. The file system then produces a directory listing. The data contained within ACLs can be used to limit access to a data object, such as a file or directory, for some or all users or groups of users. If a user has read access to a directory, however, the NTFS will return a file system directory listing to the user that includes all data objects within that directory, regardless of that user's authority for those objects as specified in the ACLs associated with those objects within that directory. Returning complete file system directory listings to users can cause confusion and potential security risks. Users who are not authorized to access data in certain data objects will still be presented with a listing of those files. Users presented with this complete directory listing may attempt to access data in files to which they are not authorized. This can cause confusion on the part of the user, or a malicious user may be able to more effectively direct unauthorized activity to sensitive data objects to which the user is unauthorized, since the file system directory listing has the name and location of that data object. Additionally, a user's productivity is adversely impacted by presenting a large number of files and/or directories to a user who only has access to a small subset of those files and directories. Presenting a user with all of the data objects in a directory requires the user to wade the listing of data objects and remember with objects are of interest to that user.

Therefore a need exists to overcome the problems with the prior art as discussed above.

### SUMMARY OF THE INVENTION

Briefly, in accordance with the present invention, a computer implemented method for providing a filtered file system directory listing includes receiving, from a process associated with a user, a file system directory listing request for a directory stored within an NTFS type file system. The user has a defined set of data object access permissions for accessing data objects in the file system. The method further includes receiving a file system directory listing for the directory that includes a corresponding entry for each data object within at least one data object. The method also includes creating a filtered file system directory by removing at least one entry within the file system directory listing. The at least one entry is removed by filtering out the at least one entry in response to the defined set of data object access permissions for the user prohibiting access to a corresponding data object that corresponds to the at least one entry within the file system directory listing. The method also includes forwarding, to the process, a filtered response that consists of the file system directory listing for the directory that consists of the file system directory listing with at least one entry removed therefrom.

In another aspect of the present invention, a filtered directory listing system includes a request interface that receives, from a process associated with a user, a file system directory listing request for a directory stored within an NTFS type file system. The user has a defined set of data object access permissions for accessing data objects in the file system. The filtered directory listing system further includes a file system interface that receives a file system directory listing for the directory and a directory listing entry processor that creates a filtered file system directory by removing at least one entry within the file system directory listing by filtering out the at least one entry within the file system directory listing in response to the defined set of data object access permissions for the user prohibiting access to a corresponding data object that corresponds to the at least one entry within the file system directory listing. The filtered directory listing system also includes a filtered directory listing generator that forwards, to the process, a filtered file system directory listing for the directory, where the filtered file system directory listing consists of the file system directory listing with the at least one entry removed therefrom.

The foregoing and other features and advantages of the present invention will be apparent from the following more particular description of the preferred embodiments of the invention, as illustrated in the accompanying drawings.

### BRIEF DESCRIPTION OF THE DRAWINGS

The subject matter that is regarded as the invention is particularly pointed out and distinctly claimed in the claims at the conclusion of the specification. The foregoing and other features and also the advantages of the invention will be apparent from the following detailed description taken in conjunction with the accompanying drawings. Additionally, the left-most digit of a reference number identifies the drawing in which the reference number first appears.

FIG. 1 illustrates an automated data processing system network architecture incorporating an exemplary embodiment of the present invention.

FIG. 2 illustrates a processing flow diagram for processing an NT File System directory listing request in accordance with an exemplary embodiment of the present invention.

FIG. 3 illustrates a complete NT File System directory listing produced by an exemplary embodiment of the present invention.

FIG. 4 illustrates a filtered NT File System directory listing produced by an exemplary embodiment of the present invention.

FIG. 5 illustrates a block diagram depicting an automated data processing system according to an exemplary embodiment of the present invention.

### DESCRIPTION OF THE PREFERRED EMBODIMENTS

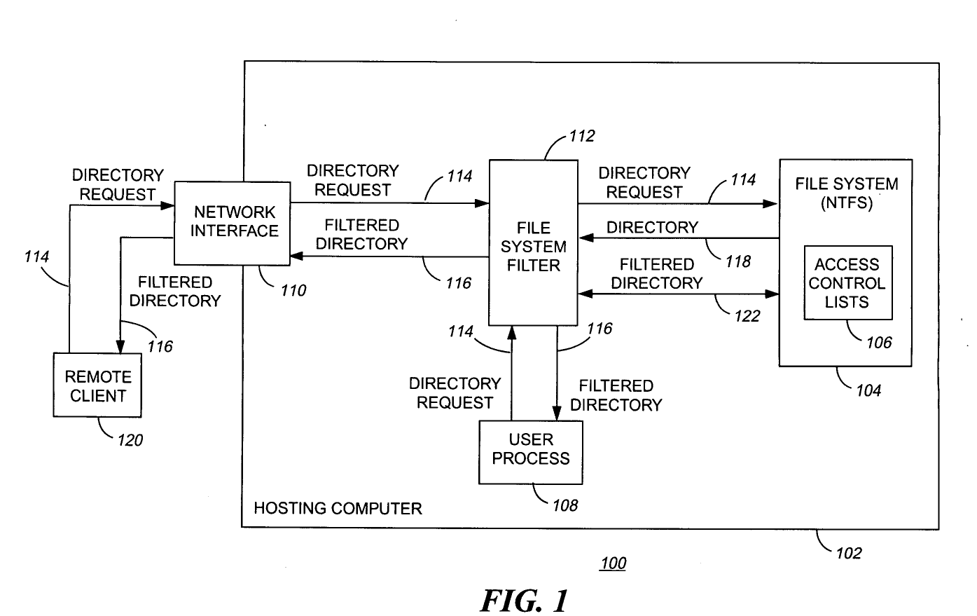

Referring now in more detail to the drawings in which like numerals refer to like parts throughout several views, FIG. 1 illustrates an automated data processing system network architecture 100 incorporating an exemplary embodiment of the present invention. The automated data processing system network architecture 100 includes a hosting computer 102. Hosting computer 102 incorporates a filtered directory listing system and further hosts other components, including a file system 104 and other components not illustrated in order to simplify this explanation of the exemplary embodiment of the present invention.

File system 104 is an NT File System (NTFS) type file system in this exemplary embodiment. The NTFS type file system is a type of file system adapted to operate more robustly in multiple user environments. For example, NTFS type file systems have transaction logs, access control structures to set permissions for directories and/or individual files. NTFS type file systems also support spanning volumes to allow files and directories to span across several physical disks. The hosting computer 102 is able to be contained within a single computer system, such as a single personal computing system. The hosting computer 102 of further embodiments is able to be divided among two or more computing systems that are interconnected and configured to operate as a distributed or cooperating computing system. The illustration of a hosting computer 102 within a single box is intended to simplify explanation of the operation of the exemplary embodiments of the present invention, and it is to be understood that embodiments of the present invention are able to operate in any suitable computing environment.

The file system 104 of the exemplary embodiment is an NTFS type file system. File system 104 is able to include only one physical data storage device, such as a disk drive, or the file system 104 is able to include multiple data storage devices that are connected to either a single computer or that are connected to several computers. File system 104 also maintains Access Control Lists (ACLs) 106. Each of the access control lists 106 maintained by the NTFS type file system of the exemplary embodiment contains data that defines permission attributes for one or more user's access to a particular data object, or groups of data objects, that is stored in the file system 104.

The hosting computer 102 of the exemplary embodiment is able to support a user process 108. A user process 108 executing on the hosting computer 102 allows a person or executing program to use the computing resources of the hosting computer 102. The hosting computer 102 further includes a network interface 110 that supports a bi-directional data connection over a data network, as is discussed below, to one or more remote clients 120. A single remote client 120 is illustrated and discussed for clarity and ease of understanding. Embodiments of the present invention are able to operate with any number of remote clients or with no remote clients and with no network interface 110 to connect remote clients to the hosting computer.

The network interface 110, in the context of this description of the automated data processing system network architecture 100, includes the resources within hosting computer 102 as well has the data communications network facilities that are external to the hosting computer 102. Network interfaces of further embodiments of the present invention are able to include any type or distribution of data communications resources to connect the hosting computer 102 to one or more remote clients 120. Some embodiments of the present invention maintain an NTFS type file system and perform associated processing on a stand-alone computer system. Such stand-alone computer systems perform file system access and associated processing without communicating over a network interface 110.

The hosting computer 102 includes a file system filter 112. The file system filter 112 includes a request interface that accepts file system directory listing requests 114, as is described below, from either the user process 108 executing on the hosting computer 102, or from one or more remote clients 120 through network interface 110. The file system directory listing request 114 specifies a directory within the NTFS type file system 104 for which the file system 104 is to supply a file system directory listing. The file system filter 112 then transmits the file system directory listing request 114 to the file system 104. The file system 104 of the exemplary embodiment then provides a file system directory listing 118 to the file system filter 112. The file system filter 112 includes a file system interface to receive the file system directory listing 118. The NTFS type file system 104 of the exemplary embodiment provides, as is described in detail below, a file system directory listing 118 that includes all data objects within the directory that is the subject of the file system directory listing request 114.

The user process 108 and remote client 120 are able to use the computing resources of the hosting computer 102 for many purposes. The hosting computer is able to provide file server, database server, web server and any other type of Internet and/or intranet services, as well as local computer services. In the course of operating, the user process 108 and the remote clients 120 are able to submit file system directory listing requests 114 for directories contained within the file system 104. Such file system directory listing requests 114 are conceptually submitted by a user that is associated with the requesting computer process. The hosing computer 102 includes an operating system that maintains a list of “users” that are associated with processes or individuals that user the resources of hosting computer 102. A “user” in this context is not required to be a natural person who is using an interactive or batch computing account maintained on the hosting computer. An example of a non-person type of “user” may be a “user” associated with a web server process. A “user” paradigm is also able to be used to identify different processes or other constructs executing on a computer and accessing the computing resources of hosting computer 102. Computing processes that are executing on either the hosting computer 102 or one of the remote clients 120 are generally associated with a “user” data structure in a conventional manner.

The ACLs included in the NTFS specify a list of permissions for one or more users with respect to data objects stored within the NTFS. Based upon the permissions defined for a particular user, the resources of hosting computer 102 are able to be made selectively available to computer account users as well as other executing computing processes.

The file system filter 112 of the exemplary embodiment contains a directory listing entry processor and a filtered directory listing generator that are able to be configured to filter the file system directory listing 118 so as to produce a filtered file system directory listing 116 for the directory specified in the file system directory listing request 114. When operating in this configuration, the file system filter 112 receives the file system directory listing 118 and removes at least one entry within the file system directory listing in order to create a filtered file system directory. The at least one entry is removed in response to the user requesting the directory listing being prohibited access to a corresponding data object that corresponds to the at least one entry within the file system directory listing. The user is prohibited access according to a defined set of data object access permissions for that user, such as are defined in the ACLs of the file system in the exemplary embodiment. The file system filter 112 of the exemplary embodiment performs this by comparing the permissions for the user that submitted the file system directory listing request 114 to the access permissions for the entries for data objects within the file system directory listing 118. These access permissions are defined in the exemplary embodiment by the access control entries (ACEs) contained within the access control list that is associated with each data object. The file system filter 112 of the exemplary embodiment makes this determination by attempting to access the data object indicated by each entry within the file system directory listing.

The operation of the file system filter 112 includes a filtered directory listing generator that generates a response that consists of a filtered file system directory listing 116 that only includes entries for data objects, such as files and sub-directories, for which the user who submitted the file system directory listing request 114 has permission to access. The user's permission to access these data objects is determined in the exemplary embodiment based upon data contained within at least one access control list that is maintained by the NTFS type file system 104. The other entries of the file system directory listing 118, which are entries for data objects to which the user is prohibited access, are removed from the filtered file system directory listing 116. The filtered file system directory listing 116 is then returned to the requesting user. The user's permission to access a data object includes, for example, permission to read the data object, write the data object and/or execute the data object as an executable object. Further embodiments of the present invention simply determine a user's permission to read the data object or any other set of permissions defined in the ACL for a data object.

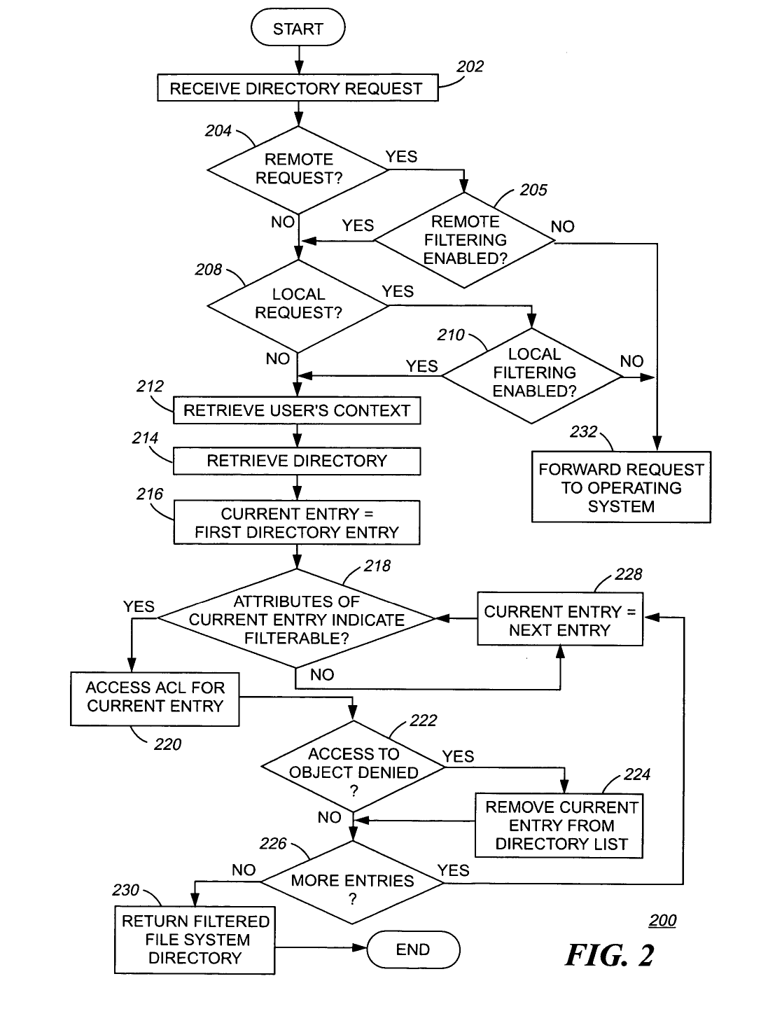

FIG. 2 illustrates a processing flow diagram for processing an NT File System directory listing request 200 in accordance with an exemplary embodiment of the present invention. The processing of an NT File System directory listing request 200 is performed by the file system filter 112 in the exemplary embodiment. Further embodiments of the present invention perform this processing as part of the network interface 110, such as within a part of the Server Message Block (SMB) processing components within Microsoft Windows NT derived operating systems. Yet further embodiments perform this processing within other components of the hosting computer 102 and/or within other computers that have data communications with hosting computer 102.

The processing of an NT File System directory listing request 200 of the exemplary embodiment begins by receiving, at step 202, a file system directory listing request 114 for a directory that is stored within a NTFS type file system 104. In response to the receipt of a file system directory listing request 114, the processing determines, at step 204, if this file system directory listing request is from a remote client 120. The operations of the exemplary embodiment are able to be configured to perform file system directory listing filtering: a) for only file system directory listing request to be returned to remote clients 120; b) for only file system directory listing requests to be returned to local user processes 108; or c) for file system directory listing requests to be returned to both remote clients 120 and local user processes 108. If the file system directory listing request 114 was determined to have been sent by a remote client 120, the processing next determines, at step 206, if filtering of file system directory listings to be returned to remote clients has been enabled. If such filtering has not been enabled, the processing forwards, at step 232, the file system directory listing request 114 to the operating system for normal processing.

If filtering of file system directory listings to be returned to remote clients has been enabled, as determined at step 206, or if the file system directory listing request 114 was not sent by a remote client 120, the processing continues by determining, at step 208, if the request was sent by a local user process 108. If the file system directory listing request 114 was determined to have been sent by a local user process 108, the processing next determines, at step 210, if filtering of file system directory listings to be returned to local user processes has been enabled. If such filtering has not been enabled, the processing forwards, at step 232, the file system directory listing request 114 to the operating system for normal processing.

If filtering of file system directory listings to be returned to local user processes 108 has been enabled, as determined at step 210, or if the file system directory listing request 114 was not sent by a local user process 108, the processing continues by retrieving, at step 212, the user's context. The user's context includes the user's security context, which includes the information required to determine the user's permissions as stored in the ACL for a data object.

After retrieving the user's context, the processing continues by retrieving, at step 214, the directory from the operating system. Retrieving the directory in the exemplary embodiment is performed by submitting a file system directory listing request 114 to the file system 104 through an appropriate software interface provided by the operating system. In the processing of the exemplary embodiment, the directory listing request 114 is not altered or modified prior to submission to the operating system. The processing of the directory listing request 114 by the operating system is also performed in a conventional manner. In response to the file system directory listing request, the file system 104, and the operating system supporting the file system 104, returns a file system directory listing 118 to the file system filter 112. This file system directory listing 118, as is produced by the file system 104 which is configured as an NTFS type file system, contains a listing of all entries of the directory that is the subject of the file system directory listing request 114, including entries to which the requester has no access permissions. The file system filter 112 of the exemplary embodiment receives this file system directory listing and then determines and removes certain entries from this file system directory listing 118 to produce filtered file system directory listing 116 according to the processing described below. Further embodiments of the present invention use any suitable alternative processing techniques to determine and remove certain file system directory listing entries from the file system directory listing 118 that is returned from the file system 104.

The processing of an NT File System directory listing request 200 of the exemplary embodiment next sets, at step 216, a current entry to be processed equal to the first directory entry. In the exemplary embodiment, a data structure pointer is used to point to, and thus identify, the current entry within the file system directory listing to be processed. The processing next determines, at step 218, if the attributes of the current entry to be process indicate that the entry is of a type that is to be processed or filtered. The processing of the exemplary embodiment is configured with at least one file system directory listing element type that is to be processed. The processing of the exemplary embodiment does not process directory listing entries that are not within that at least one type, and therefore only determines if entries which are of those types are to be removed. The processing of the exemplary embodiment is configured, for example, to process directory entries that are a) files or directories, b) not special directories, and c) not journal entries. The processing then proceeds by accessing, at step 220, the Access Control List (ACL) for the current entry of the file system directory listing.

The processing next determines, at step 222, if access to the object is denied to the user associated with the requesting process by the permissions specified in the ACL for the data object corresponding to the current entry. The exemplary embodiment of the present invention performs this determination by comparison of the data contained in the ACL for that data object to the Security Identifier (SID) for the user associated with the process that submitted the file system directory listing request 114. This comparison is performed in the exemplary embodiment via conventional means. In response to determining that the user associated with the process that submitted the request does not have permission to access the data object associated with the current entry, the processing of the exemplary embodiment next removes, at step 224, the current entry from the file system directory listing.

If access to the data object that is associated with the current entry is not denied, or after the current entry has been removed from the file system directory listing, the processing continues by determining, at step 226, if there are more entries to be processed within the file system directory listing. If there is determined to be more entries to process, the processing sets, at step 228, the current entry to be processed to the next entry within the file system directory listing. The processing then continues by determining, at step 218, if the attributes of the current entry indicate the entry is to be processed and the subsequent processing, as is described above, is repeated. If it was determined, at step 226, that there are no more entries within the file system directory listing to be processed, the processing then returns, at step 230, the filtered file system directory listing 116, which consists of the file system directory listing 118 returned by the NTFS type file system of the exemplary embodiment with entries removed for directories and files for which the user associated with the requesting process does not have permission to access. The processing for this file system directory listing request then terminates.

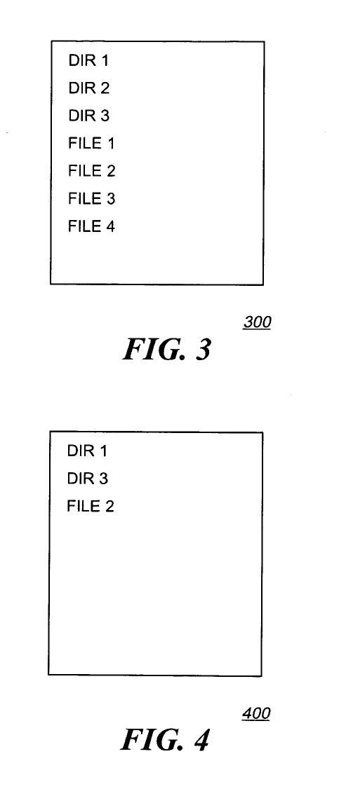

FIG. 3 illustrates a complete NT File System file system directory listing 300 as produced by an exemplary embodiment of the present invention. The complete NT File System directory listing 300 corresponds to the file system directory listing 118 described above. The complete NT File System directory listing 300 shows three sub-directories: DIR1, DIR2, and DIR3, as well as four files: FILE 1, FILE 2, FILE3 and FILE4. This corresponds to the file system directory listing commonly returned by an NTFS type file system.

FIG. 4 illustrates a filtered NT File System file system directory listing 400 produced by an exemplary embodiment of the present invention. The filtered NT File System directory listing 400 corresponds to the filtered file system directory listing 116 described above. The filtered NT File System directory listing 400 shows two sub-directories: DIR1, and DIR2, as well as one file: FILE 2. The entries contained within the complete NT File System directory listing 300 for which the user requesting the file system directory listing does not have access are not included in the filtered NT File System directory listing 400.

### Exemplary Automated Data Processing System

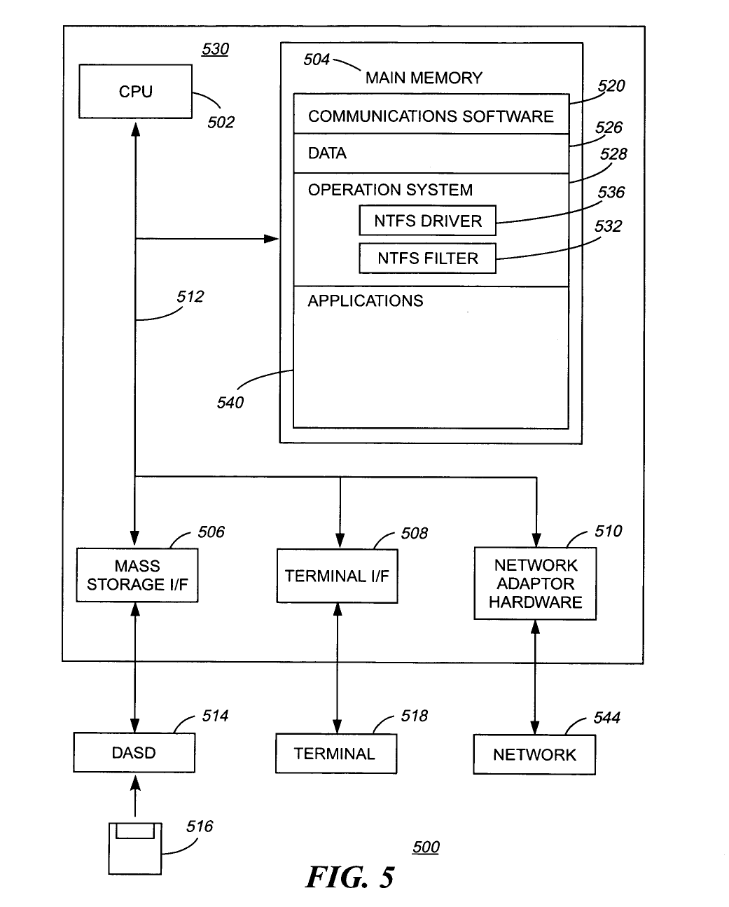

FIG. 5 illustrates a block diagram depicting an automated data processing system 500, such as the Hosting Computer 102, according to an embodiment of the present invention. The automated data processing system 500 is based upon a suitably configured processing system adapted to implement the exemplary embodiment of the present invention. Any suitably configured processing system is similarly able to be used as an automated data processing system 500 by embodiments of the present invention. The automated data processing system 500 includes a computer 530. Computer 530 has a processor 502 that is connected to a main memory 504, mass storage interface 506, terminal interface 508 and network adapter hardware 510. A system bus 512 interconnects these system components. Mass storage interface 506 is used to connect mass storage devices, such as data storage device 514, to the computer system 500. One specific type of data storage device is a floppy disk drive, which may be used to store data to and read data from a floppy diskette 516, which contains a signal bearing medium. Another type of data storage device is a data storage device configured to support NTFS type file system operations.

Main Memory 504 contains communications software 520, data 526 and an operating system image 528. Although illustrated as concurrently resident in main memory 504, it is clear that the communications software 520, data 526 and operating system 528 are not required to be completely resident in the main memory 504 at all times or even at the same time. The automated data processing system 500 utilizes conventional virtual addressing mechanisms to allow programs to behave as if they have access to a large, single storage entity, referred to herein as a computer system memory, instead of access to multiple, smaller storage entities such as main memory 504 and data storage device 514. Note that the term “computer system memory” is used herein to generically refer to the entire virtual memory of automated data processing system 500.

Although only one CPU 502 is illustrated for computer 530, computer systems with multiple CPUs can be used equally effectively. Embodiments of the present invention further incorporate interfaces that each includes separate, fully programmed microprocessors that are used to off-load processing from the CPU 502. Terminal interface 508 is used to directly connect one or more terminals 518 to computer 503 to provide a user interface for user process 108. These terminals 518, which are able to be non-intelligent or fully programmable workstations, are used to allow system administrators and users to communicate with the automated data processing system 500. The Terminal 518 is also able to consist of user interface devices that are connected to computer 530 and controlled by terminal interface hardware included in the terminal I/F 508 that includes video adapters and interfaces for keyboards and a mouse.

Operating system 528 is a suitable multitasking operating system such as the Windows XP or Windows Server 2003 operating system. Embodiments of the present invention are able to use any other suitable operating system. Some embodiments of the present invention utilize architectures, such as an object oriented framework mechanism, that allows instructions of the components of operating system 528 to be executed on any processor located within automated data processing system 500. The operating system 528 of the exemplary embodiment includes an NTFS driver component 536 that controls the operation of an NTFS type file system 104. The operating system 528 of the exemplary embodiment further contains an NTFS filter 532 that operates as a file system filter 112 and performs the processing an NT File System directory listing request 200. Further embodiments of the present invention allocate differently these components within computer 530 or among several data processing systems.

Network adapter hardware 510 is used to provide an interface to the shared communications network 120. Embodiments of the present invention are able to be adapted to work with any data communications connections including present day analog and/or digital techniques or via a future networking mechanism. The network adapter hardware 510 and network 504 are part of the network interface 110 described above.

Although the exemplary embodiments of the present invention are described in the context of a fully functional computer system, those skilled in the art will appreciate that embodiments are capable of being distributed as a program product via floppy disk, e.g. floppy disk 516, CD ROM, or other form of recordable media, or via any type of electronic transmission mechanism.

### Non-Limiting Software and Hardware Examples

Embodiments of the invention can be implemented as a program product for use with a computer system such as, for example, the computing environment shown in FIG. 1 and described herein. The program(s) of the program product defines functions of the embodiments (including the methods described herein) and can be contained on a variety of computer readable media. Illustrative computer readable medium include, but are not limited to: (i) information permanently stored on non-writable storage medium (e.g., read-only memory devices within a computer such as CD-ROM disk readable by a CD-ROM drive); (ii) alterable information stored on writable storage medium (e.g., floppy disks within a diskette drive or hard-disk drive); or (iii) information conveyed to a computer by a communications medium, such as through a computer or telephone network, including wireless communications. The latter embodiment specifically includes information downloaded from the Internet and other networks. Such computer readable media, when carrying computer-readable instructions that direct the functions of the present invention, represent embodiments of the present invention.

In general, the routines executed to implement the embodiments of the present invention, whether implemented as part of an operating system or a specific application, component, program, module, object or sequence of instructions may be referred to herein as a “program.” The computer program typically is comprised of a multitude of instructions that will be translated by the native computer into a machine-readable format and hence executable instructions. Also, programs are comprised of variables and data structures that either reside locally to the program or are found in memory or on storage devices. In addition, various programs described herein may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

It is also clear that given the typically endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, etc.) It should be appreciated that the invention is not limited to the specific organization and allocation or program functionality described herein.

The present invention can be realized in hardware, software, or a combination of hardware and software. A system according to a preferred embodiment of the present invention can be realized in a centralized fashion in one computer system, or in a distributed fashion where different elements are spread across several interconnected computer systems. Any kind of computer system—or other apparatus adapted for carrying out the methods described herein—is suited. A typical combination of hardware and software could be a general purpose computer system with a computer program that, when being loaded and executed, controls the computer system such that it carries out the methods described herein.

Each computer system may include, inter alia, one or more computers and at least a signal bearing medium allowing a computer to read data, instructions, messages or message packets, and other signal bearing information from the signal bearing medium. The signal bearing medium may include non-volatile memory, such as ROM, Flash memory, Disk drive memory, CD-ROM, and other permanent storage. Additionally, a computer medium may include, for example, volatile storage such as RAM, buffers, cache memory, and network circuits. Furthermore, the signal bearing medium may comprise signal bearing information in a transitory state medium such as a network link and/or a network interface, including a wired network or a wireless network, that allow a computer to read such signal bearing information.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

What is claimed is:

1. A computer implemented method for providing a filtered file system directory listing on a host computer, the method comprising:
receiving, from a process associated with a user, a file system directory listing request for a directory stored within an NTFS type file system, wherein the user has a defined set of data object access permissions;
receiving a file system directory listing for the directory, wherein the file system directory listing includes a corresponding entry for each data object within at least one data object;
removing at least one entry within the file system directory listing by filtering out the at least one entry within the file system directory listing in response to the defined set of data object access permissions for the user prohibiting access to a corresponding data object that corresponds to the at least one entry within the file system directory listing, thereby creating a filtered file system directory; and
forwarding the filtered file system directory listing to the process, the filtered file system directory listing consisting of the file system directory listing with the at least one entry removed therefrom.

2. The computer implemented method of claim 1, wherein the removing at least one entry within the file system directory listing is based upon data contained within at least one access control list maintained by the NTFS type file system.

3. The computer implemented method of claim 1, wherein the NTFS type file system is maintained on a stand-alone computing system.

4. The computer implemented method of claim 1, wherein the removing at least one entry within the file system directory listing comprises comparing a user's security identifier to data contained within an access control list associated with the corresponding data object.

5. The computer implemented method of claim 1, wherein the removing at least one entry is performed in response to the defined set of data object access permission prohibiting read access to the corresponding data object.

6. The computer implemented method of claim 1, further comprising:
defining at least one file system directory listing element type to be processed; and
determining a set of entries within the file system directory listing that correspond to the at least one file system directory listing element type to be processed, and
wherein the removing at least one entry within the file system directory listing only processes the set of entries.

7. The computer implemented method of claim 6, wherein the at least one file system directory listing element type to be process includes files and directories, and excludes special directories and journal entries.

8. A filtered directory listing system, comprising:
a request interface that receives, from a process associated with a user, a file system directory listing request for a directory stored within an NTFS type file system, wherein the user has a defined set of data object access permissions;
a file system interface that receives a file system directory listing for the directory;
a directory listing entry processor that removes at least one entry within the file system directory listing by filtering out the at least one entry within the file system directory listing in response to the defined set of data object access permissions for the user prohibiting access to a corresponding data object that corresponds to the at least one entry within the file system directory listing, thereby creating a filtered file system directory; and
a filtered directory listing generator that forwards a filtered file system directory listing to the process, the filtered file system directory listing consisting of the file system directory listing with the at least one entry removed therefrom.

9. The filtered directory listing system of claim 8, wherein the directory listing entry processor removes at least one entry within the file system directory listing based upon data contained within at least one access control list maintained by the NTFS type file system.

10. The filtered directory listing system of claim 8, wherein the NTFS type file system is maintained on a stand-alone computing system.

11. The filtered directory listing system of claim 8, wherein the directory listing entry processor removes at least one entry within the file system directory listing by comparing a user's security identifier to data contained within an access control list associated with the corresponding data object.

12. The filtered directory listing system of claim 8, wherein the directory listing entry processor removes at least one entry is performed in response to the defined set of data object access permission prohibiting read access to the corresponding data object.

13. The filtered directory listing system of claim 8, wherein the directory listing entry processor further:
defines at least one file system directory listing element type to be processed; and
determines a set of entries within the file system directory listing that correspond to the at least one file system directory listing element type to be processed, and
wherein the directory listing entry processor removes at least one entry within the file system directory listing by only processing the set of entries.

14. The filtered directory listing system of claim 13, wherein the at least one file system directory listing element type to be process includes files and directories, and excludes special directories and journal entries.

15. A computer readable medium including a program which, when executed by a processor, performs operations for providing a filtered file system directory listing, the operations comprising:
receiving, from a process associated with a user, a file system directory listing request for a directory stored within an NTFS type file system, wherein the user has a defined set of data object access permissions;
receiving a file system directory listing for the directory, wherein the file system directory listing includes a corresponding entry for each data object within at least one data object;
removing at least one entry within the file system directory listing by filtering out the at least one entry within the file system directory listing in response to the defined set of data object access permissions for the user prohibiting access to the at least one entry within the file system directory listing, thereby creating a filtered file system directory; and
forwarding the filtered file system directory listing to the process, the filtered file system directory listing consisting of the file system directory listing with the at least one entry removed therefrom.

16. The computer readable medium of claim 15, wherein the operations for removing at least one entry within the file system directory listing remove based upon data contained within at least one access control list maintained by the NTFS type file system.

17. The computer readable medium of claim 15, wherein the NTFS type file system is maintained on a stand-alone computing system.

18. The computer readable medium of claim 15, wherein the operations for removing at least one entry within the file system directory listing comprise operations for comparing a user's security identifier to data contained within an access control list associated with the corresponding data object.

19. The computer readable medium of claim 15, further comprising operations for:
defining at least one file system directory listing element type to be processed; and
determining a set of entries within the file system directory listing that correspond to the at least one file system directory listing element type to be processed, and
wherein the removing at least one entry within the file system directory listing only processes the set of entries.

20. The computer readable medium of claim 19, wherein the at least one file system directory listing element type to be process includes files and directories, and excludes special directories and journal entries.
